(19) United States
(12) Patent Application Publication
(10) Pub. No.: US 2008/0274796 A1
(43) Pub. Date: Nov. 6, 2008

(54) System and Method for Enhanced Gaming Platform Interactions

(75) Inventor: Robert R. LUBE, Countryside, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wells Gardner Electronics Corporation, McCook, IL (US)

(21) Appl. No.: 12/115,189

(22) Filed: May 5, 2008

Related U.S. Application Data
(60) Provisional application No. 60/924,192, filed on May 3, 2007.

(51) Int. Cl. A63F 9/24; A63F 13/00

(52) U.S. Cl. 463/25; 463/31

(57) ABSTRACT

A gaming console configured with picture-in-picture (PIP) capability for use to gain entry into a group level or competitive level of play. The PIP window is used to form teams or provide information related to group play. The PIP screen may also be used to make request for special services such as making hotel or restaurant reservations, advanced request for getting a car from the concierge, and may also be used to send information about the location of the game console being used by a player so that others may know where the player is currently located.

### CROSS-REFERENCES TO RELATED APPLICATIONS

This application claims the benefit under 35 U.S.C. §119(e) to Provisional Application No. 60/924,192 filed on May 3, 2007, which is hereby incorporated by reference in its entirety herein.

### BACKGROUND OF THE INVENTION

1. Field of the Invention

The invention relates generally to gaming platforms or consoles, and more particularly, to systems and methods for providing enhanced user feature functionality on gaming platforms and consoles.

2. Related Art

The gaming industry has provided a wide range of games to be enjoyed by people for leisure activities, and often further provides a full range of conveniences for the guests, such as hotels and restaurants in addition to the gaming centers or casinos. Games offered in casinos and the like often include games of chance or wager-based games, which are often provided via some form of platform such as a slot machine or electronic console (generically “gaming console”) implementing one or more specific types of games. Such games typically allow players to make a wager using actual currency or some equivalent form of value, e.g., tokens or credit.

Most modern gaming consoles employ computer-generated graphics and one or more types of games that are implemented, in part, by displaying graphics and text on a video display. These games may include any number of games of chance that are typically programmed, in part, to statistically payout winnings in a substantially random fashion, such as slot machines, poker, or keno, for example. Typically, users interact with these gaming consoles using the video display that displays graphical and textual representations of the game being played. That is, substantially the entire display screen is typically dedicated to presentations of data, symbols, and animation related to the game, while in operation.

However, the use of substantially the entire display for presentation of the wager-based game may be rather limiting because the player is ordinarily not provided with other options that are unrelated to the current game in progress, or one that expands the player's experience by presenting more game-related options. For example, the gaming console is typically localized and involves only one game being played on a console at any particular time.

Many casino environments are expansive, and may include hundreds of gaming consoles placed throughout the casino, in multiple wings or floors. Consequently, the player often finds himself or herself located among a multitude of gaming consoles as part of a complex of gaming operations. The location of such a player may be unknowable to others outside the immediate vicinity of the player without significant difficulty and time.

Further, convenient access to the overall supply of services in a casino megaplex that might include lounge, hotel, and restaurant operations is not easily accessible from a gaming console. A player typically must terminate play to make a restaurant reservation, for example.

Accordingly, there is a need to be able to expand the options available to the users of electronic or computer based platforms, particularly in the casino environment.

### BRIEF SUMMARY OF THE INVENTION

The invention satisfies the foregoing needs and avoids the drawbacks and limitations of the prior art by providing an apparatus and methods for gaming consoles to provide advanced features in a gaming environment and/or to provide for a player to access other services.

According to at least one aspect of the invention, a method of implementing a wager-based game, comprising the steps of providing a gaming device having a video display, the gaming device including electronics configured to implement one or more wager-based games, configuring the gaming device to implement a local wager-based game, the local wager-based game being configured to award a prize upon an occurrence of one or more events, and configuring the gaming device to implement a group wager-based game, the group wager-based game being configured to award a payout upon the occurrence of one or more events.

The gaming device includes an odds table, the odds table including odds correlated to relative chances of the occurrence of the one or more events, and wherein the gaming device is configured to determine a payout amount based at least in part on the odds table.

The group wager-based game is configured to determine a payout amount based at least in part on a wager pool, the wager pool including wagers contributed by one of more players of the group wager based game. The group wager-based game includes a wager pool, and further including the step of configuring the group wager based game to include a plurality of players participating in the group wager based game, wherein each player in the plurality of players competes for at least a portion of the wager pool. Each player of the plurality of players competes for the at least a portion of the wager pool in pari-mutuel competition with the other players in the plurality of players. At least two players of the plurality of players compete for the at least a portion of the wager pool in direct competition with each other.

The local wager-based game further includes a predetermined threshold level to be achieved to obtain eligibility to enter the group wager-based game. The threshold level is based on at least one of wager level, available credit, point total, and game session duration.

According to another aspect of the invention, a method of implementing a wager-based game, including the steps of: providing a gaming device, the gaming device being configured to implement one or more wager-based games, the gaming device having a video display, the video display having picture-in-picture (PIP) capability, providing a local wager-based game on the gaming device, the local wager-based game being configured to award a prize upon the occurrence of one or more events, the local wager-based game being displayed on the video display, and providing a group wager based game on the gaming device, the gaming device being configured to allow a player to selectively play a group wager-based game implemented on the gaming device, the group wager-based game being configured to award a prize upon the occurrence of one or more events, the group wager-based game being displayed in a PIP window on the video display.

The gaming device includes an odds table, the odds table including odds correlated to relative chances of the occurrence of the one or more events, and wherein the gaming device is configured to determine a payout amount based at least in part on the odds table.

The group wager-based game is configured to determine a payout amount based at least in part on a wager pool, the wager pool including wagers contributed by one or more players of the group wager based game.

The local wager-based game further includes a predetermined threshold level to be achieved to obtain eligibility to enter the group wager-based game. The threshold level is based on at least one of wager level, available credit, point total, and game session duration.

The group wager-based game includes a wager pool, and further including the step of configuring the group wager-based game to include a plurality of players participating in the group wager based game, wherein each player in the plurality of players competes for at least a portion of the wager pool. Each player of the plurality of players competes for the at least a portion of the wager pool in pari-mutuel competition with the other players in the plurality of players. At least two players of the plurality of players compete for the at least a portion of the wager pool in direct competition with each other.

The video display has an active area, the active area including the region of the display capable of displaying a video signal, and the PIP window occupies substantially the entire active area. The method including a touch screen device in association with the video display.

According to another aspect of the invention, a system for facilitating the procurement of information or services, including: a gaming device, the gaming device being configured to present one or more wager based games, a video display operatively associated with the gaming device, the video display having picture-in-picture (PIP) capability, a touch screen device operatively associated with the video display, and a server in communication with the gaming device, the server being configured to transmit information to and receive information from the gaming device, the gaming device being configured to display at least some of the information received from the server in a PIP window implemented on the video display.

According to another aspect of the invention, a system for providing communication services from a gaming device, including: a gaming device, the gaming device being configured to present one or more wager based games, a video display operatively associated with the gaming device, the video display having picture-in-picture (PIP) capability, a touch screen device operatively associated with the video display, a server in communication with the gaming device, the server being configured to transmit information to and receive information from the gaming device, the gaming device being configured to display at least some of the information received from the server in a PIP window implemented on the video display, and an interactive display in the PIP window, the interactive display being configured to display information in graphics and/or text.

According to another aspect of the invention, a method of making a reservation using a picture-in-picture (PIP) window in a gaming console, the method including the steps of: playing a game at a gaming console configured for picture-in-picture (PIP), and making a request for service to a casino associated service provider, wherein the request is made from a PIP window at the gaming console. The casino associated service provider comprises a hotel or a restaurant. The casino associated service provider participates in a player tracking system.

The request includes any one of a restaurant reservation, a request for check-out, and a notice for advanced service. The request includes a location identifier which is associated with a game console. The location identifier is accessible by a guest of a hotel for conveying the location of the game console. The identifier is accessible by a phone system.

According to another aspect of the invention, a game platform, including: a display to visually provide a game of chance, wherein the display is configured to dynamically present a picture-in picture (PIP) window, and at least one user control to select or play the game of chance and to provide data into the PIP window or to select an option presented in the PIP window, wherein the display is used to play the game of chance to achieve a threshold to gain entry to a group game and the PIP window is used to display information related to the group game.

According to another aspect of the invention, a game platform, including: a display to visually provide a game of chance, wherein the display is configured to dynamically present a picture-in picture (PIP) window, and at least one user control to select or play the game of chance and to provide data into the PIP window, or to select an option presented in the PIP window, wherein the PIP window is used to make a request for a service unrelated to the game of chance.

The request for service includes any one of a reservation, a checkout notice, and a location identifier. The request for service includes access to a player tracking system. The PIP window is used to make a request for service related to the player tracking system. The service is access to player information and statistics. The service includes awarding of a comp.

According to another aspect of the invention, a game platform, including: a display to visually provide a game of chance, wherein the display is configured to dynamically present a picture-in picture (PIP) window, wherein the picture-in-picture window is configured to display a game of chance and a non-PIP area of the display is configured to display information related to at least one of: advertisement information and information related to the game of chance.

The system further including at least one user control to select or play the game of chance or to select an option presented in the non-PIP area, wherein the option is used to make a request for a service unrelated to the game of chance.

According to another aspect of the invention, a method of accessing a player tracking system using a picture-in-picture (PIP) window in a gaming console, the method including the steps of: playing a game at a gaming console having a video display configured for PIP; requesting access to the player tracking system, wherein the request is made from a PIP window displayed on the video display, and wherein access to the player tracking system includes access to information and statistics about at least one game-player. The at least one game-player can request comps through access to the player tracking system.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is an illustration showing an exemplary console, according to principles of the invention;

FIG. 2A is an illustration of a graphical display representing a exemplary game, according to principles of the invention;

FIG. 2B is an illustration showing a game display similar to FIG. 2A, but with a second window produced by picture-in-picture technology, according to principles of the invention;

FIG. 2C is an illustration of an embodiment showing a game display in a PIP window with adjacent advertising and/or information in non-PIP display areas, according to principles of the invention;

FIG. 2D is an illustration of an exemplary marketplace display in a PIP window, according to principles of the invention;

FIG. 3 is a flow diagram of an embodiment showing steps of using a PIP window to enter a group wagering game or a competitive level of play, according to principles of the invention;

FIG. 4 is a flow diagram of an embodiment showing steps of using the PIP window to enter a group wagering game, according to principles of the invention;

FIG. 5 is a block diagram of an embodiment of an exemplary architecture for enabling player in a casino type environment to communicate with other facility services, according to principles of the invention;

FIG. 6 is an embodiment of an exemplary architecture for enabling player at a casino type environment to communicate with other facility services; and

FIG. 7 is a flow diagram of an embodiment showing steps of using the PIP window to discover information, communicate, or obtain resources, according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

The system and methods of the invention may provide for enhanced player experience and functionality through the platforms typically employed in games of chance, and which employ some form of a video display, including, without limitation, LCD, plasma screen, CRT, or similar display devices. The games of chance may include any of a variety of wager-based games, such as video poker, video slots, keno, or the like.

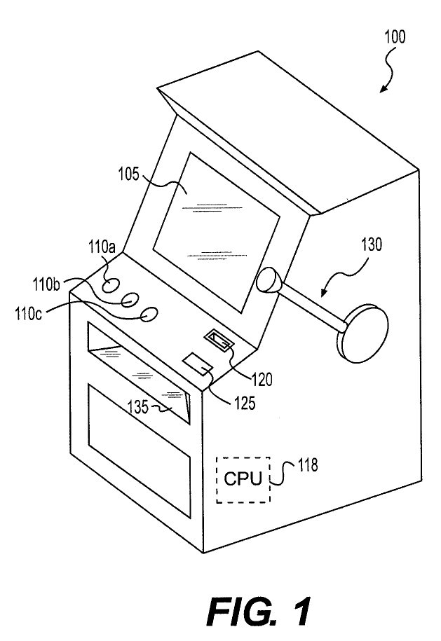

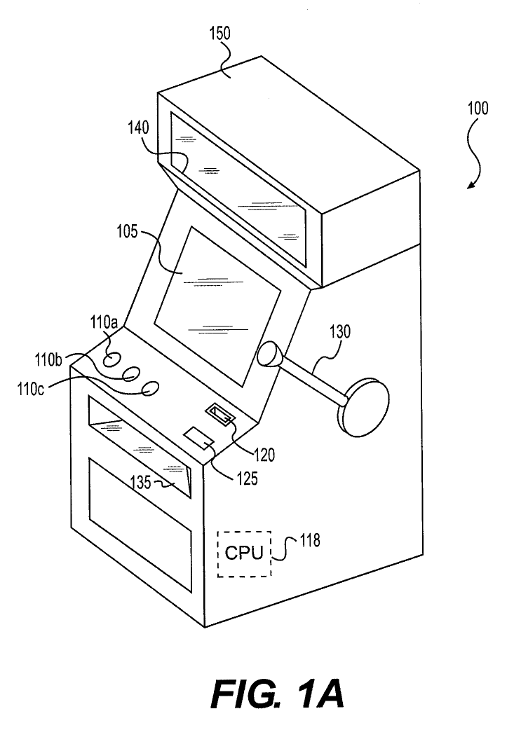

FIG. 1 is an illustration showing an exemplary gaming console, generally designated by reference numeral 100. Gaming console 100 includes a display device 105, and may optionally include one or more of: user input controls 110a-110c, an optional joystick (not shown) for interaction with a game, a token or money slot 120, a card reader 125 for reading a player's electronically-coded card for identification and/or payment, and a game lever 130 for initiating or interacting with a game. A payout dispenser 135, such as a coin tray, may also be present. The display 105 may also include a touch screen device associated with the video display 105 for entering of data or user selections.

Gaming console 100 may also include audio input and output circuitry (not shown) to deliver audio for communications or game related sounds, and/or to receive audio input from a player. Gaming console 110 may also be configured with appropriate network interfaces for linking the gaming consoles 110 to the casino's local area network.

User inputs 110a-110c and/or touch screen device may be used to interact with games or otherwise respond to prompts issued by the software related to the console 100, and which are displayed on display 105. In certain embodiments, money slot 120 can be configured to accept tokens, coins, or paper bills. Card reader 125 may be configured to read encoded cards for a player to provide payment for wagering activity, or provide and record other information and statistics, such as the amount, frequency, and duration of a player's gaming sessions at a particular casino, often referred to as player tracking. The encoded cards may be associated with an account with established credit or money limits, or be pre-loaded with credits. The encoded cards may further be encoded with an identification of the user for security, and may also include a password control. In certain embodiments, the card may be the player's hotel room key card.

Gaming console 100 is typically controlled by a microprocessor complex 118 with supporting electronic components to run the onboard software and to provide communications support with programs and servers running remotely. The software is generally related to the control, communications, and operation of the gaming console 100 and may be stored in read-only memory (ROM), erasable memory (EEPROM) or in volatile memory. Software may be further or alternately stored on a remote server across a network. A storage device such as a hard drive, for example, may also be employed for storing software and data.

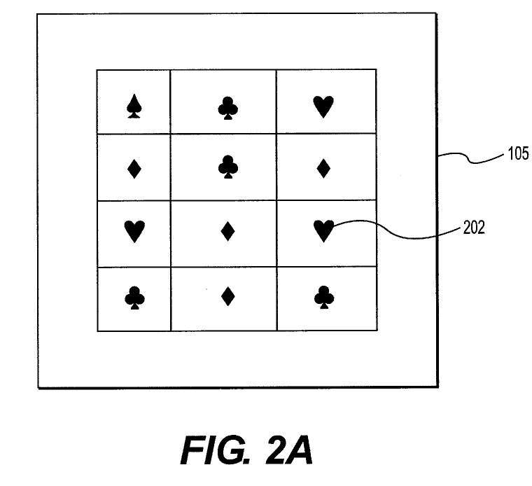

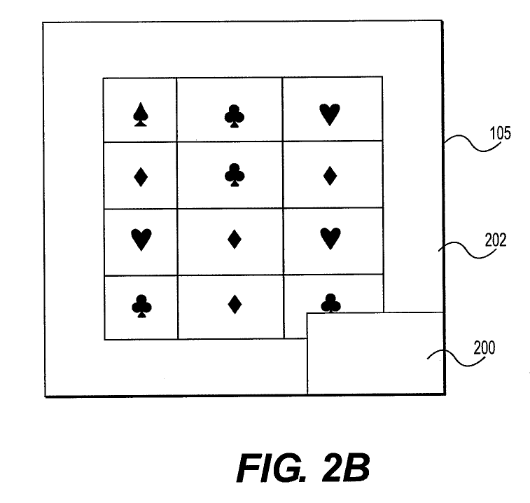

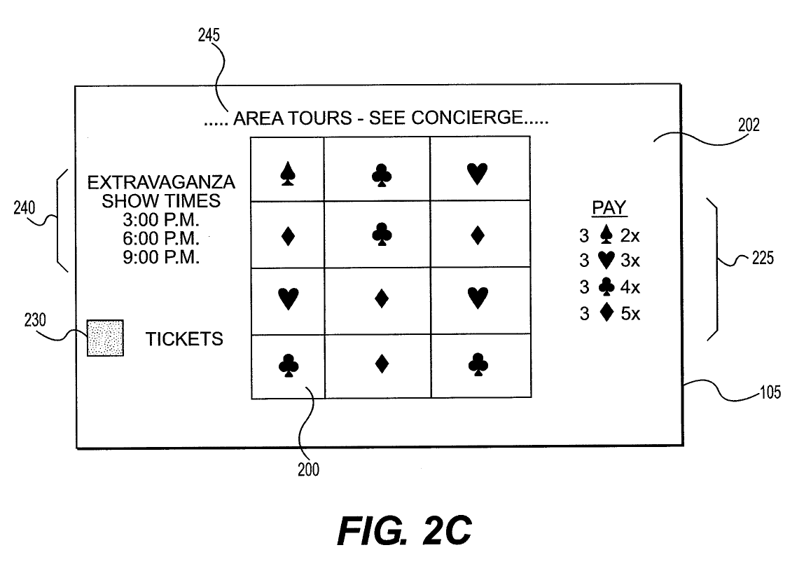

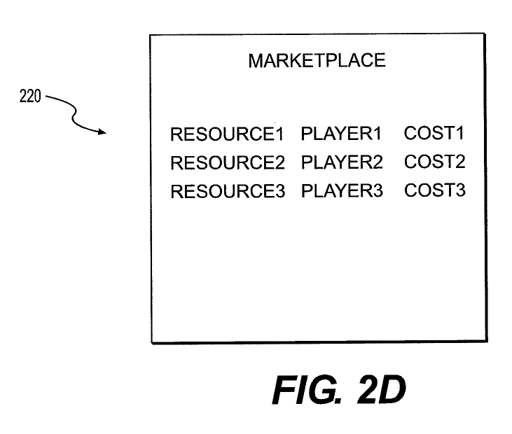

FIG. 2A is an illustration of a graphical display representing a exemplary game display that a player may view during play. The actual data content of the display may vary depending on the particular game implemented by the gaming console 100 or selected by a player. Types of games may include nearly any genre, but the game implemented is preferably a wager-based game, such as video slots or video poker and the like. However, while the simple version shown in FIG. 2A is a common slot machine-type game, the scope and complexity of implementable games is not intended to be limited by this simple illustration.

FIG. 2B is an illustration showing a game display similar to FIG. 2A, but with a second window produced by picture-in-picture (PIP) technology, generally denoted by reference numeral 200. The PIP window 200 is dynamically produced either when activated by the player or by an associated software application in response to a game condition, or a user prompt. The PIP window 200 may be used to deliver information to a user, or prompt for information to be entered by a user, or provide another game or aspect of a game to the player.

PIP technology is often implemented on a scaler board associated with a video display. Of course, persons having ordinary skill in the art will appreciate that other arrangements may alternatively be used to implement PIP. PIP provides a second channel for a video signal, which may be displayed in a subsidiary window 200 in a video display.

By using PIP technology, an independently-driven picture is displayed within the larger display. In some embodiments, there may be a plurality of PIP windows opened in the larger display. The PIP window 200 may be used to deliver information separate from the local display 202 (which is usually the larger display, but not necessarily the larger display) and to provide general information or other game-related data to the player, or to allow a user to interact with and submit information through the PIP window 200. Preferably each PIP window is assigned a pre-designated location within the larger display, but may be relocated by the player, if desired. Moreover, the PIP window may be enlarged or reduced in size by using the touch screen, or user input controls 110a-110c, for example. The PIP window 200 may be of any desired shape, size, or configuration.

FIG. 2C is an illustration of an embodiment showing a game displayed in the PIP window with informational displays in the non-PIP display area. The PIP window 200 displays the game while other information is displayed in one or more non-PIP areas, such as areas designated as 225, 240 and 245. The non-PIP area 225 shows an exemplary Pay table that provides payout information that relates to the game being displayed in the PIP window 200. For example, a row of all Spades would payout two times the wager amount, a resulting row of all three hearts would pay out three times the wager amount, and so forth. The Pay table may be extensive in the information that it delivers, as appropriate for the type of game being played, and may be expanded to include other non-PIP areas, including the area beneath the PIP window 200.

The non-PIP area designated as 240 may be an advertisement such as to convey events such as an event that the player might wish to attend. In this example, the advertisement of non-PIP area 240 provides information of an “Extravaganza Show” along with scheduled show times. If the player chooses to obtain tickets, the process may be initiated by selecting the “Tickets” button 230 that would lead to additional screens to obtain necessary information to reserve or purchase tickets. Non-PIP area 245 is an exemplary advertisement or informational banner that might be used to deliver advertisements. This exemplary banner might scroll across the top of the display 202 and might include multiple and diverse types of advertisements, and/or general information. Any of these non-PIP areas might include touch sensitive selection “buttons” to permit feedback from the player or selection of an option associated with the display.

The embodiment of FIG. 2C may be implemented on newer electronic displays, which are increasingly becoming more popular, having aspect ratios such as 16:9 and 16:10, as opposed to the older/traditional ratio of 5:4, for example. This embodiment has a benefit that addresses a problem of backwards compatible software that might stretch the display on newer wide screens. With the PIP window(s) 200 and one or more adjacent non-PIP display areas available (such as areas 225, 240 and/or 245), a traditional 5:4 aspect ratio PIP window may be implemented for the game display, which would not appear to be stretched, while allowing room any side(s) of the PIP window for other functions such as advertisements, general information, game related information like Pay tables and the like.

In the embodiment of FIG. 2C, the Pay table might originate from a first channel that is preferably programmed in the game's firmware, or otherwise controlled by a processor. Alternatively, a digital video disc (DVD) or Internet connection may provide a video signal (which may be especially desirable in a video display in a top-box). The video display might be for advertisements and could optionally switch to a second channel in a bonus mode, whereupon the player plays the game in part based on the top-box display. The second channel could also display jackpot awards.

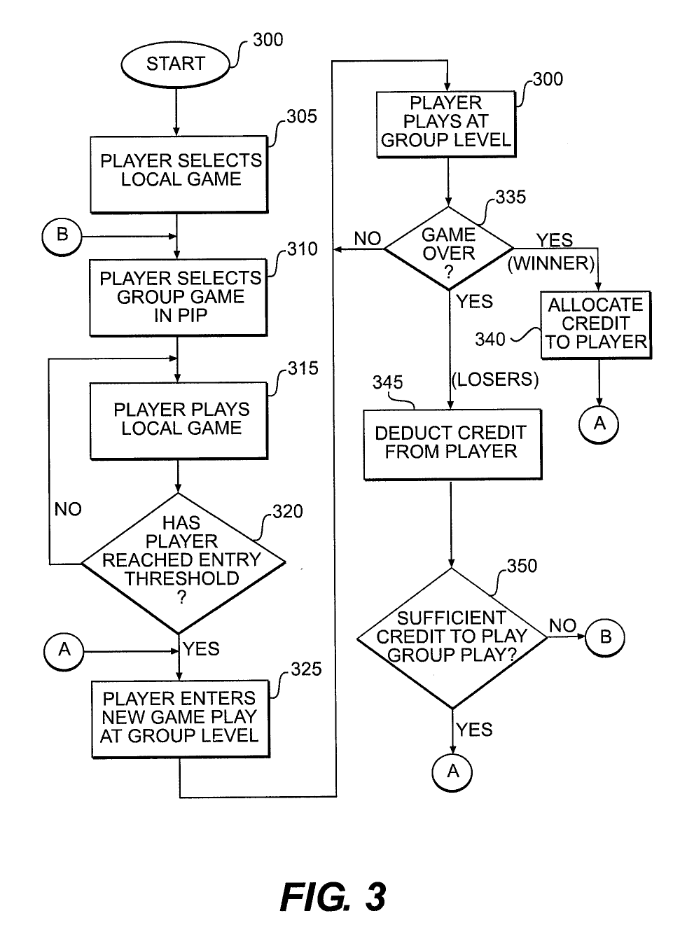

FIG. 3 is a flow diagram of an embodiment showing steps of employing a PIP window in conjunction with a gaming console and video display to enter a group wagering game or a competitive level of play, starting at step 300. At step 305, a player may select a game for playing locally, and either deposit tokens or money, or using a pre-authorized card having a value to place a wager. A local game may be any game that is ordinarily intended to be implemented on a single console, with the player competing against the game, such as conventional video poker or video slots. In such local games, a player's chances of winning as well as the payout are determined by the rules implemented in the particular game being played, irrespective of similar or identical games being implemented on other consoles throughout the casino or at other remote locations. Rules may be based in part on an odds table stored in the gaming console electronics or on an associated server. An odds table may provide odds of certain occurrences occurring, and may further correlate payout information to such odds.

In networked games, a player initiates a gaming session for a game that is being played by one or more other players, and the games and players are linked in that a player's odds of winning may or may not be augmented by the presence and number of other players, and the payout for winning may be increased due to the presence of a larger player pool and thus larger pool of money eligible for winning by a player of the networked game. The gaming sessions of each particular player need not be simultaneous, to the extent that the game being played does not require a head-to-head contest, but each gaming session on a networked game may result in a portion of a player's wagers being transferred to a pool of wagers to which other wagers from other gaming sessions are contributed, and which may be won only by a player of a networked game, but not a player of a local game.

Local game at step 305 may be, for example, video slots. The game may be configured such that the player may make wagers, and play the video slots according to well-known methods. Additionally, the game may include one or more features allowing a player to accumulate achievements in one or more categories, such as session duration (i.e. the length of time a player has been substantially engaged in playing the game), number of wins, type of wins (e.g. wins having odds of winning above a predetermined level), and so forth. To the extent a player does not accumulate sufficient achievements in the one or more categories, the player continues to play the game at the local level.

At step 310, the player may open the PIP window to view possible networked group games that may be possible to enter, and further select a game for requested entry. Step 310 may occur before, during or after the player plays a local game. Step 310 may optionally be omitted.

A group game is one that is linked to one or more servers or consoles over a network, and in which the presence of more than one player may increase the amount of money available to be won by a player of the wager-based game on a particular console, and/or augment the odds of a player's chances of winning. A group game preferably includes an odds table. During play, a player may compete against other players at other gaming consoles (either local to the casino or at an unrelated location but in communication with the local casino gaming system) for a prize, or the player may become part of a team of players to compete against another team for a prize. Alternatively, the player may play compete for a portion of pooled wagers in a pari-mutuel fashion, and need not compete head-to-head with other players.

At step 315, the player plays the local game and accrues winnings and/or acquires bonus awards. Of course, the player may also lose. At step 320, a check is made as to whether the player has earned or obtained a sufficient level of achievement (either game wins, prize awards/credits, or wager amount) to be eligible for group competition. If the player has not reached the required threshold, the player may continue play at the local level at step 315.

If, however, the threshold for entry into group play has been achieved, at step 325, the player may enter competition at the group level typically by responding to an invitation or prompt presented on the gaming console display either in the main screen or in the PIP window that is automatically opened. In the alternative, the player may invoke the PIP window to selectively enter competition at the group level, such as through a touch screen selection or a button on the console. Optionally, the group play game may require an entrance fee which may be paid by token, coin, accrued credit, or by use of a card.

At step 330, the player plays the group game, which may further include group information and statistics being displayed in the PIP window. Alternatively, the group game may be played in the PIP window. The group game may be defined with various game rules such as, for example, by time-period limits for play with the winner being the higher achiever, by an ultimate goal with the winner being the one to achieve the ultimate goal first, or the last player remaining in the game. The group play may also be pari-mutuel, and need not be head-to-head.

Carrying forward the above-described example of a video slot type local game, the player may play the video slot game at a group or networked level after achieving a certain threshold of achievements, or paying a predetermined amount of a wager. While playing the video slot game at a group level, the video slot game may or may not appear different than the local implementation of the video slot game, but, unlike a video slot game implemented locally, the payout may be increased due to the pooling of wagers from numerous players of the networked video slot games. The group game may further be implemented in a PIP window, which may be present only while a player is playing a group game, and is not present while the player is playing the game at a local level.

Optionally, for some types of group games, one or more game resources may need to be acquired or used to advance in a game. These game resources may be acquired by achievement or by locating the resources acquired by other players during play, for example. In some games, a particular resource for advancing in a game may be bartered or traded among players in the PIP window, such as perhaps by exchanging one resource with another resource, or by outright purchase, for example. Typically, each player would have to judiciously decide whether to agree to such a barter or sale. In these situations, the PIP window also becomes a common marketplace for game resources, where game specific resources may be exchanged, bartered, bought or sold. A player can view available resources and add or remove offerings of resources on the marketplace PIP display. By judicious trading, a player may advance in the group play, or alternatively by selectively withholding a game resource.

In some games, resources may be randomly distributed by a master gaming server (i.e., game management software managing the overall group play for all players in the game, such as server 505, or other remote server) prior to game play. Typically, this is distributed so that the resources are fairly distributed among the group players, with no advantage at the beginning of play. Game resources may be entered (offered) or selected for acquisition via the user controls or touch screen selections, typically in the PIP window.

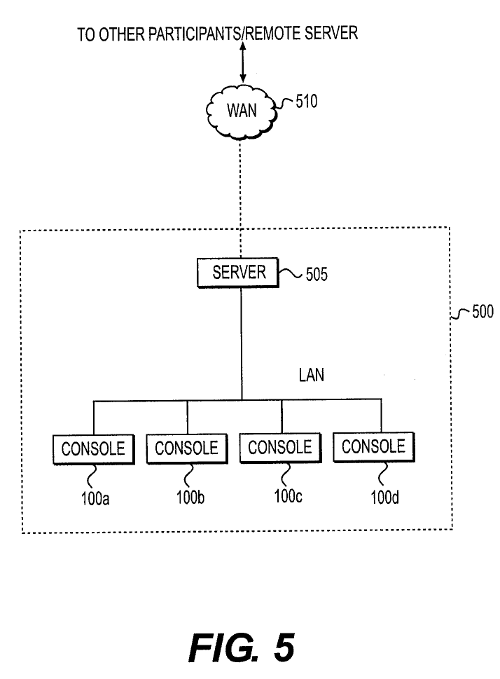

FIG. 2D is an illustration of an exemplary marketplace display in PIP, according to principles of the invention, generally denoted by reference numeral 220. The marketplace display 220 is an example of one type of display that may be used during the course of group game play and includes such information as game resources (e.g., Resource1, Resource2, Resource3) that may be available during the course of game play and any optional cost (e.g., cost1, cost2, cost3) and which player in the game (e.g., Player1, Player2, Player3) has the resource for obtaining such a resource. In some embodiments, the available resources may be obtained from the game server (such as server 505, FIG. 5) in lieu of or in addition to resources from other players. Other types of information such as team formations, team drafting, point accrual, game progress information, and the like may be displayed in the PIP window, before or during or after group play.

Continuing at step 330, the player plays the game according to pre-established rules for the group game. Typically, the player plays the game to acquire one or more prizes and/or to advance in rankings among players. The player, of course, may exit the game at anytime, which may cause a forfeiture of wagers, if applicable. At step 335, a determination is made whether the game is over, typically as determined by a time-period or a player achieving or not achieving an ultimate goal or level of achievement. If not over, play continues at step 330. If, however, group play is over, then at step 340, for a winner of the group game, any prize or credit award is applied to the winning group player. Play may then resume at step 305, 310, or 325, or alternatively the winning player may stop play.

For losing players, at step 345, a cost of play such as money, a point count, or other penalty may optionally be deducted from the loser's accumulations. At optional step 350, a check is made to determine whether each losing player still meets or exceeds the threshold requirements for group play. If not, the game may resume at step 310, which is at local play. If sufficient credit remains, or if player has otherwise met a pre-determined threshold value, then group play may be re-initiated at step 325. Optionally, a player may quit at anytime.

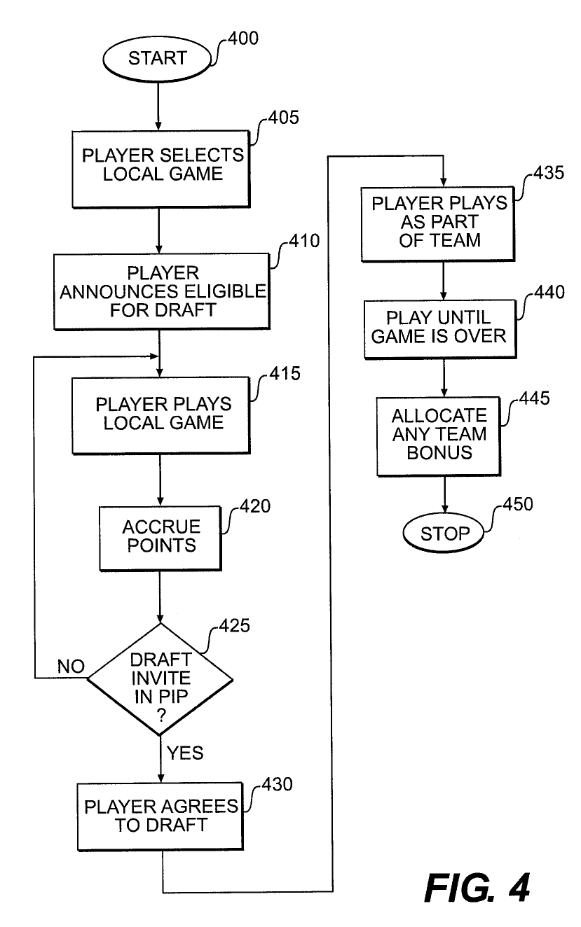

FIG. 4 is a flow diagram of another embodiment showing steps of using the PIP window to enter a group wagering game, starting at step 400. At step 405, a player selects a game at the local level which is related to, or is the same game, for entry into group play. A player might play at a local level to develop skill or a handicap, or to achieve a level to exceed a threshold for entering into a group game. This local game is typically played in the main display window of the gaming console video display. If a player has a predetermined wager level, record of a level of skill, or a handicap (perhaps recorded on his or her player card), then local play may be optionally circumvented and eligibility for draft is immediate (i.e., steps 415 and 420 become optional and may not be performed), and the player may wait for a positive invite at step 425, or continue to play locally until such invitation occurs.

At step 410, the player announces eligibility or desire for a draft to be considered for group play. This draft process may be carried out by the microprocessor in the local gaming console, or on a centralized server (not shown) and viewed in the PIP window, which at this stage may be the window to facilitate drafting of players at the group level. A draft is a process whereby a team is formed to play other teams during a group play. Teams may be formed across different systems and coordinated by one or more system servers (such as server 505, FIG. 5, for example). A team may be comprised of one or more than one players. The primary system server may manage the drafting process to create competitive teams to promote parity. The system server may perform the selection automatically or may designate a team manager (a player) as the selector of the team members. For some games, the teams may be formed with a handicap system, where each player has a handicap score, each team being assigned players to form approximately equal combined skill levels, when handicaps are considered. A team manager is typically one who has achieved a high score at local play (or with game score considered), or may simply be a first volunteer for forming a team. The number of team members is related to the specific type of game to be played. In team group play, the teams compete for an ultimate goal or prize, perhaps limited by time. Step 410 is optional and may be selectively omitted.

At optional step 415, the player plays at the local level. At step 420, the player accrues points, bonuses, skill level, and/or handicap. At step 425, a check is made whether an invite is made (a draft), which typically appears in the PIP window. At this time, a team roster may appear, along with other information, such as player statistics, location, points, achievements, and so forth. At step 430, the player may agree to the draft and becomes part of the team. At step 435, the player plays as part of a team effort. The PIP window may be used at this stage to display overall team data and competitive team information. Moreover, the PIP window may be used to exchange communication with team members for strategy reasons, or to acquire or post resources for use during the game. Alternatively, the PIP window may be used to implement the team-based game, during which time the local game may or may not remain displayed on display 202, or an idle display is displayed on display 202.

An exemplary game scheme to be played according to the local and networked system as previously described may be video poker played at the local level and another type of poker game, such as Texas Hold 'Em, played at the group level. Players at a console may play video poker and optionally declare eligibility or desire to play in a networked Texas Hold 'Em game. The networked Texas Hold 'Em game is implemented on a plurality of consoles, at any one of which a player plays the Texas Hold 'Em game against players at other consoles either within the casino or at remote locations.

At step 440, the game is played until a time is reached, or a prize is achieved by one of the teams, or some other predetermined endpoint. At step 445, any prize, bonus or credits is awarded by the system. Any handicaps may be updated or skill levels revised. This handicap or skill identity may be recorded on the player's card. At step 450, the game ends.

FIG. 5 is a block diagram of an embodiment showing an exemplary architecture for supporting the processes of the steps of FIGS. 3 and 4, generally denoted by reference numeral 500. The architecture 500 includes gaming consoles 100a-100d preferably having PIP capability, a server 505 interconnected with the gaming consoles 100a-100d preferably by a LAN. The architecture 500 may be coupled to a wide area network 500 such as the Internet to interconnect other gaming systems and remote servers and remote players. The connectivity to remoter servers may include peer-to-peer connectivity for implementing head-to-head or pari-mutuel game play, sharing of game statistics and information and/or for managing common group games. A master server for any particular game may be pre-identified or may be established in real-time by negotiations among candidate servers. In this way, remote participation is possible among geographically dispersed players.

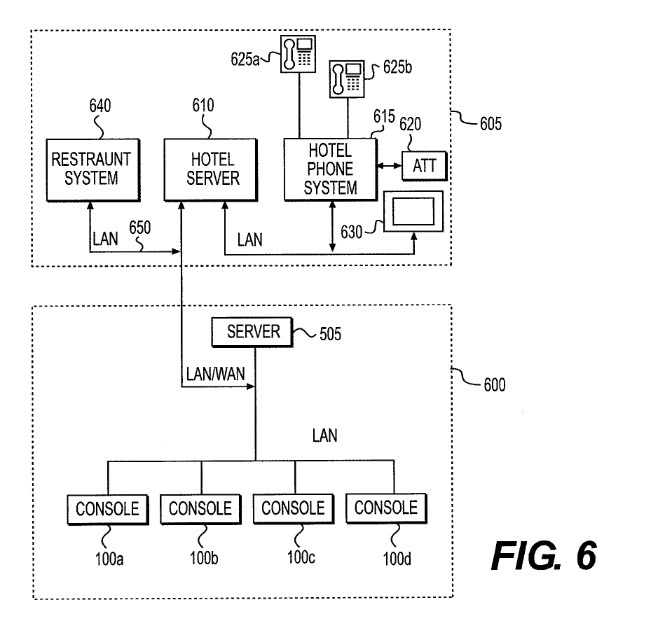

FIG. 6 is an embodiment of an exemplary architecture for enabling play at a casino type environment to communicate with other facility services, according to principles of the invention. The local casino environment 600 may include various components as explained previously in relation to FIG. 5. The local casino environment may be generally near (geographically) or essential contiguous with a complex 605 such as a hotel having dining services (e.g., one or more restaurants) for example. The complex 605 may have a hotel server 610 for running various hotel operations and in communication with server 505. The complex 605 may also have a hotel phone system 615 (perhaps a PBX with a computer-telephony interface for open software controls) with attendant consoles 620 and computer interfaces 630 (such as for front desks, attendants or concierge operations, etc.). The complex 605 may also have one or more restaurant servers 640 for managing restaurant operations. In some embodiments, two or more of these servers (i.e., 505, 640, 610) may actually be combined, forming one server. The hotel phone system 615 (which may also have its own server and/or may be equipped with voice over Internet protocol (VOIP) capabilities) has room phones 625a and 625b and may be in communication with hotel server 610. Hotel server 610 may be in communication with restaurant server 640 and server 505, typically by LAN or WAN.

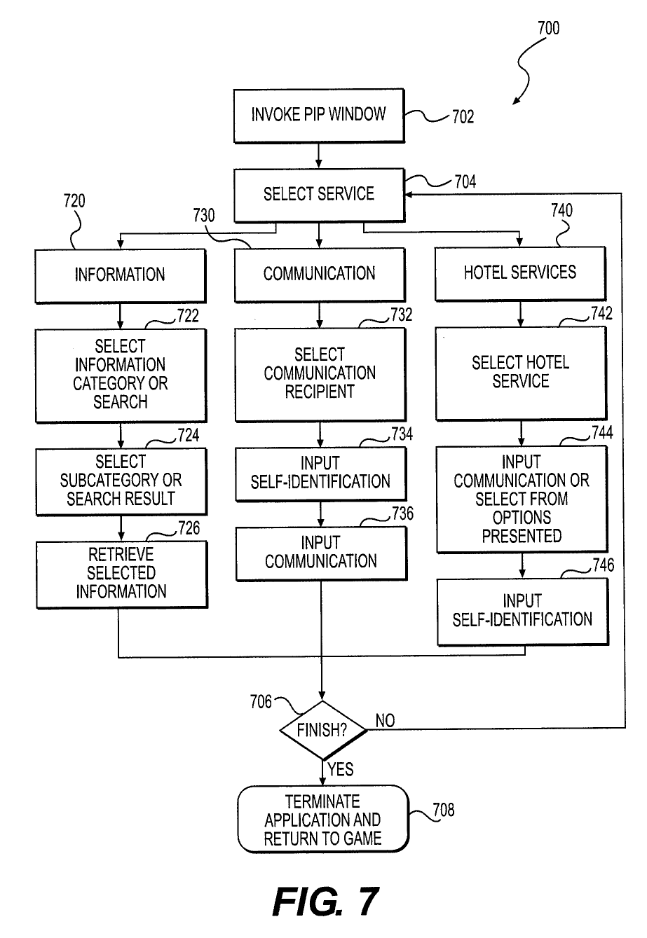

A player at one of the gaming consoles 100a-100d may desire to obtain hotel information, communicate with someone remotely, or arrange for services without terminating the gaming session. FIG. 7 is a flow diagram illustrating another embodiment of the invention wherein a gaming console may be used in conjunction with a network to allow a player to obtain information, communicate, and/or arrange for services. As shown in FIG. 7, a player at any one of consoles 100a-d in FIG. 6, for example, may use the console to access certain services or information. To begin, the player may invoke a PIP window 702 through interaction with a touch sensitive screen, or an external button on the console, or the like. After invoking PIP window, the player is provided with a range of information and services available through interaction with the console via the PIP window, including hotel information (e.g. telephone numbers, lists of shops and restaurants, locations of hotel facilities, and/or hours of operation, etc.), communication options (e.g. communicate with player's room, front desk, and so forth), or hotel services (e.g. reservations, valet, order drinks, player tracking, and so forth). At step 704, the player selects a category presented in order to avail themselves of the options available under those categories.

One of the categories presented at step 704 may be an information menu 720. The information menu may be a list of information, such as hotel departments and telephone numbers, and/or may be searchable by way of a text box and touch screen type pad. At step 722, the player selects the information subcategory, either by touching the category or by use of an external button on the console. At step 724, the information sub-category or search results are displayed to the player. Information category may include restaurant, for example, and information sub-category may include restaurants in a hotel by name or cuisine. The player selects an information subcategory or a search result. Step 724 may optionally be omitted, to the extent that a player does not require further selection of subcategories or search results. At step 726, the system retrieves the selected information from, for example, server 505 in FIG. 6 and displays it to the player, who may then make use of the information. Information for display in the PIP window may also be updated and changed on server 505 for display at gaming consoles 100a-d. Thereafter, the player may indicate completion at step 706, such as through selection of a touchscreen option or an external button, and at step 708 the application 700 terminates and the player may resume playing the game on the console. Alternately, at step 706 a player may return to step 704 to retrieve additional information, or select another option, such as communication 730 or hotel services 740.

At step 704, a player may select communication services. At step 730, a player may be presented with communications services options that may include, for example, options to send communications to the player's hotel room, concierge services, valet and so forth. At step 732, the player selects communication recipient, such as the player's hotel room. To avail themselves of the communications system, players may optionally be required to provide identification at step 734, such as with a hotel room key card or player card that may be inserted into a reader on console 100a-d, or by entering a unique code provided to the player at check-in and which may be input via a touch screen or the like. Identification may be made known to the hotel server 610 via server 505

At step 736, the player inputs the communication to be delivered to the selected recipient or recipients. For example, the player may input the communication by way of a touch screen type pad, or may select from pre-written text that may have blanks to be filled in by the player, if indicated. Examples of such pre-written text may be include “Meet me at the restaurant in 30 minutes” or “I will meet you in the room in 45 minutes,” where the locations and time values may be filled in by the player using a touch screen type pad or selections available by interaction with external buttons on the console. Once the message is entered, the message may be sent to the television in the player's room or to a voicemail message directed to a phone registered to the player's room, to the extent the message is intended to be sent to the player's room. Messages sent to hotel personnel may be displayed on a computer terminal used by the personnel to alert them of the message so that the player's request may be addressed. Once the request is addressed and/or completed, hotel personnel may input a response at a terminal that is transmitted through server 505, and displayed to the player at the console. Preferably, a message would be displayed to the player to the extent server 505 could verify that the player was remaining at the console at the time the message was to be delivered, such as by verification that a player card corresponding to the player is still associated with the console. Thereafter, the player may indicate completion at step 706 as previously described, or return to step 704 to repeat the operation or access other options.

At step 704 a player may alternately select a hotel services menu. Hotel services may include, for example, reservations at restaurants, valet, front desk, bellman, bar, and/or player tracking. At step 740, a list of hotel services may be presented to the player, who may then select a service at step 742. After service selection, the player may input communications to be relayed to a particular hotel service. Examples of such communications may be to direct that a valet deliver a car at a certain time, or to request that casino personnel come to the console to take an order for refreshments or the like. Such communications may be in the form of pre-written text with or without blanks to be filled in by the player, similar to the method described at step 736. User identification may further optionally be required, similar to the method described at step 734.

The player may also make reservations at hotel restaurants, or purchase tickets to a show, for example. Information regarding reservation availability may be updated in server 505 through restaurant system 640. To make a reservation, an interactive menu may be presented to the player that allows the player to select the restaurant, the number of people, and the reservation time. Reservation time may be a function of available seating for the number of people selected for the reservation, and presented to the player as selectable time slots. For example, the player may select Restaurant A and select a reservation for four persons. The server 505 may query a reservation database to determine whether and at what time slots a reservation for four persons is available. Thereafter, the information may be presented to the player as selectable icons on a touch screen or otherwise selectable with external buttons, which the player may choose to make the desired hotel reservation. A confirmation number may further be provided to the player confirming the reservation.

Similarly, a player may use the system described in steps 740, 742, 744 and 746 to make a purchase, such as purchase of tickets, which would ordinarily further include payment for the tickets by the player by way of accumulated credits on the game being played, or by way of a credit card or cash, for example. A player may use of the system described in steps 740, 742, 744 and 746 to order food or drink from the lounge or a restaurant within the hotel.

If the hotel or casino utilizes player tracking, a player may use the system described in steps 740, 742, 744, and 746 to access the hotel's player tracking system. Player Tracking services are commonly known in the art and are described in U.S. Pat. Nos. 6,302,793 and 5,655,961. Generally, a player tracking system is operated by a hotel or casino to foster goodwill between the hotel and the player and establish and maintain player loyalty to the hotel; hotels often reward players who wager a large amount of money with “comps,” such as free food, rooms, and other products and services. The type and value of the comp the player receives is often based on a player-rating or a point system, such that a player can increase his points and/or rating by playing and wagering more. The comps may be awarded by discretion of the hotel or the player may choose to redeem accumulated points for specific comps.

For example, at steps 742, 744 the player may select to view the player's tracking statistics, including accumulated points and ranking. The player may then identify himself or herself by touch screen or by card swipe. As discussed above, an encoded card may be encoded with a player's identification and record of the player's gaming sessions, including the player's ranking and/or point accumulation. The player's statistics may then be presented on the screen and the player may then choose to redeem points for comps or other hotel or casino services. Thereafter, the player may indicate completion at step 706 as previously described, or return to step 704 to repeat the operation or access other options.

The steps described in connection with FIG. 7 may be accomplished while engaged in a game on the main display, which may pause or switch to idle mode while the player is interacting with the PIP window to access hotel or casino services. The steps may eliminate the need for a secondary LCD display on the gaming console. Alternately, the steps may be performed by a user that is not actively playing a game prior to step 702.

A player at one of the gaming consoles 100a-100d may identify himself or herself by touch screen or by card swipe, such as a hotel room key card or a player card, which is made know to the hotel server 610 via server 505. A guest in a hotel room or at another other hotel phone may want to locate the whereabouts of the player that has identified himself to the server 505 and server 610. This identification may be correlated to the room in which the player may be registered. Since the hotel server 610 is in communication with hotel system 615, this information may be made available on demand to the guest in the rooms having phone 625a, or on a television in the room, for example. By dialing the front desk or by dialing a special information number, a guest (perhaps a traveling partner having permission to access information) may discover the location of a player associated with the room, which can be conveyed by the phone system or by an attendant, for example. The conveyed location may be as simple as conveying a game console identifier associated with the player's location. The identification may also include a casino room identification, if there are multiple casino rooms with rows of gaming consoles, for example. The player location may also be displayed on a hotel television channel on an info screen channel available in the room registered to the player, for example. Ordinarily, such location information would not be otherwise publicly available, for security reasons, but would be accessible by hotel personnel or to an individual with permission to access the information, for example.

Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of implementing a wager-based game, comprising the steps of:
providing a gaming device having a video display, the gaming device including electronics configured to implement one or more wager-based games;
configuring the gaming device to implement a local wager-based game, the local wager-based game being configured to award a prize upon an occurrence of one or more events; and
configuring the gaming device to implement a group wager-based game, the group wager-based game being configured to award a payout upon the occurrence of one or more events.

2. The method of claim 1 wherein the gaming device includes an odds table, the odds table including odds correlated to relative chances of the occurrence of the one or more events, and wherein the gaming device is configured to determine a payout amount based at least in part on the odds table.

3. The method of claim 2 wherein the group wager-based game is configured to determine a payout amount based at least in part on a wager pool, the wager pool including wagers contributed by one of more players of the group wager based game.

4. The method of claim 1 wherein the local wager-based game further includes a predetermined threshold level to be achieved to obtain eligibility to enter the group wager-based game.

5. The method of claim 4 wherein the threshold level is based on at least one of wager level, available credit, point total, and game session duration.

6. The method of claim 1 wherein the group wager-based game includes a wager pool, and further including the step of configuring the group wager based game to include a plurality of players participating in the group wager based game, wherein each player in the plurality of players competes for at least a portion of the wager pool.

7. The method of claim 6 wherein each player of the plurality of players competes for the at least a portion of the wager pool in pari-mutuel competition with the other players in the plurality of players.

8. The method of claim 6 wherein at least two players of the plurality of players compete for the at least a portion of the wager pool in direct competition with each other.

9. A method of implementing a wager-based game, comprising the steps of:
providing a gaming device, the gaming device being configured to implement one or more wager-based games, the gaming device having a video display, the video display having picture-in-picture (PIP) capability;
providing a local wager-based game on the gaming device, the local wager-based game being configured to award a prize upon the occurrence of one or more events, the local wager-based game being displayed on the video display; and
providing a group wager based game on the gaming device, the gaming device being configured to allow a player to selectively play a group wager-based game implemented on the gaming device, the group wager-based game being configured to award a prize upon the occurrence of one or more events, the group wager-based game being displayed in a PIP window on the video display.

10. The method of claim 9 wherein the gaming device includes an odds table, the odds table including odds correlated to relative chances of the occurrence of the one or more events, and wherein the gaming device is configured to determine a payout amount based at least in part on the odds table.

11. The method of claim 10 wherein the group wager-based game is configured to determine a payout amount based at least in part on a wager pool, the wager pool including wagers contributed by one or more players of the group wager based game.

12. The method of claim 9 wherein the local wager-based game further includes a predetermined threshold level to be achieved to obtain eligibility to enter the group wager-based game.

13. The method of claim 12 wherein the threshold level is based on at least one of wager level, available credit, point total, and game session duration.

14. The method of claim 9 wherein the group wager-based game includes a wager pool, and further including the step of configuring the group wager-based game to include a plurality of players participating in the group wager based game, wherein each player in the plurality of players competes for at least a portion of the wager pool.

15. The method of claim 14 wherein each player of the plurality of players competes for the at least a portion of the wager pool in pari-mutuel competition with the other players in the plurality of players.

16. The method of claim 14 wherein at least two players of the plurality of players compete for the at least a portion of the wager pool in direct competition with each other.

17. The method of claim 9 wherein:
the video display has an active area, the active area comprising the region of the display capable of displaying a video signal; and
the PIP window occupies substantially the entire active area.

18. The method of claim 9 further including a touch screen device in association with the video display.

19. A system for facilitating the procurement of information or services, comprising:
a gaming device, the gaming device being configured to present one or more wager based games;
a video display operatively associated with the gaming device, the video display having picture-in-picture (PIP) capability;
a touch screen device operatively associated with the video display; and
a server in communication with the gaming device, the server being configured to transmit information to and receive information from the gaming device, the gaming device being configured to display at least some of the information received from the server in a PIP window implemented on the video display.

20. A system for providing communication services from a gaming device, comprising:
a gaming device, the gaming device being configured to present one or more wager based games;
a video display operatively associated with the gaming device, the video display having picture-in-picture (PIP) capability;
a touch screen device operatively associated with the video display;
a server in communication with the gaming device, the server being configured to transmit information to and receive information from the gaming device, the gaming device being configured to display at least some of the information received from the server in a PIP window implemented on the video display; and
an interactive display in the PIP window, the interactive display being configured to display information in graphics and/or text.

21. A method of making a reservation using a picture-in-picture (PIP) window in a gaming console, the method comprising the steps of:
playing a game at a gaming console configured for picture-in-picture (PIP); and
making a request for service to a casino associated service provider, wherein the request is made from a PIP window at the gaming console.

22. The method of claim 21, wherein the casino associated service provider comprises a hotel or a restaurant.

23. The method of claim 21, wherein the casino associated service provider participates in a player tracking system.

24. The method of claim 21, wherein the request includes any one of a restaurant reservation, a request for check-out, and a notice for advanced service.

25. The method of claim 21, wherein the request includes a location identifier which is associated with a game console.

26. The method of claim 25, wherein the location identifier is accessible by a guest of a hotel for conveying the location of the game console.

27. The method of claim 26, wherein the identifier is accessible by a phone system.

28. A game platform, comprising:
a display to visually provide a game of chance, wherein the display is configured to dynamically present a picture-in picture (PIP) window; and
at least one user control to select or play the game of chance and to provide data into the PIP window or to select an option presented in the PIP window, wherein the display is used to play the game of chance to achieve a threshold to gain entry to a group game and the PIP window is used to display information related to the group game.

29. A game platform, comprising:
a display to visually provide a game of chance, wherein the display is configured to dynamically present a picture-in picture (PIP) window; and
at least one user control to select or play the game of chance and to provide data into the PIP window, or to select an option presented in the PIP window, wherein the PIP window is used to make a request for a service unrelated to the game of chance.

30. The game platform of claim 29, wherein the request for service includes any one of a reservation, a checkout notice, and a location identifier.

31. The game platform of claim 29, wherein the request for service includes access to a player tracking system.

32. The game platform of claim 31, wherein the PIP window is used to make a request for service related to the player tracking system.

33. The game platform of claim 32, wherein the service is access to player information and statistics.

34. The game platform of claim 32, wherein the service includes awarding of a comp.

35. A game platform, comprising:
a display to visually provide a game of chance, wherein the display is configured to dynamically present a picture-in picture (PIP) window,
wherein the picture-in-picture window is configured to display a game of chance and a non-PIP area of the display is configured to display information related to at least one of: advertisement information and information related to the game of chance.

36. The system of claim 35, further comprising at least one user control to select or play the game of chance or to select an option presented in the non-PIP area, wherein the option is used to make a request for a service unrelated to the game of chance.

37. A method of accessing a player tracking system using a picture-in-picture (PIP) window in a gaming console, the method comprising the steps of:
playing a game at a gaming console having a video display configured for PIP;
requesting access to the player tracking system, wherein the request is made from a PIP window displayed on the video display; and
wherein access to the player tracking system includes access to information and statistics about at least one game-player.

38. The method of claim 37, wherein the at least one game-player can request comps through access to the player tracking system.
